(19) United States
(12) Patent Application Publication
(10) Pub. No.: US 2008/0295472 A1
(43) Pub. Date: Dec. 4, 2008

(54) RETENTION DEVICE FOR SEPARATING COMBINE AUGER FINGER MATERIALS AND AGRICULTURAL MATERIAL ENGAGEMENT METHOD

(76) Inventor: SCOTT K. THOMPSON, Erie, PA (US)

Correspondence Address: LORD CORPORATION;PATENT & LEGAL SERVICES, 111 LORD DRIVE, P.O. Box 8012, CARY, NC, 27512-8012, US

(21) Appl. No.: 12/132,740

(22) Filed: Jun. 4, 2008

Related U.S. Application Data
(60) Provisional application No. 60/941,853, filed on Jun. 4, 2007.

(51) Int. Cl. A01D 46/00; A01D 75/18; G06F 17/00

(52) U.S. Cl. 56/10.4; 56/12.4; 56/12.7; 701/50

(57) ABSTRACT

A finger for a crop gathering auger for an agricultural combine, including an elastomeric tethering outrigger which arches a failure region of the finger and will retain a free end of the finger in connection with a mounting end thereof when the failure region is broken.

### CROSS REFERENCE

This application claims the benefit of, and incorporates by reference, U.S. Provisional Patent Application No. 60/941,853 filed on Jun. 4, 2007.

### FIELD OF THE INVENTION

The invention relates to the field of agricultural harvesting machines and devices for engaging and harvesting agricultural crops and goods. The invention relates to the field of combines. The invention relates to the field of rotary conveyors. More particularly the invention relates to the field of agricultural harvesting auger fingers for agricultural harvesting combines for harvesting agricultural crops.

### SUMMARY OF THE INVENTION

In an embodiment the invention includes an auger finger. The auger finger includes a mounting end portion. The auger finger includes an elongate free end portion opposite the mounting end portion. The auger finger includes a failure region at a predetermined location connecting the mounting and free end portions. The failure region is constructed to be weaker than the mounting end portion so as to break and disconnect the mounting and free end portions when the finger is subjected to a predetermined side loading condition. The auger finger includes an elastomeric tether connected between the free end portion and the mounting end portion and arching the failure region with at least a first elastomeric outrigger.

In an embodiment the invention includes a method of engaging an agricultural material. The method includes providing an unbroken nonelastomeric agricultural material engagement body having a first end and a distal second end, with a link between said first end and said second end, the link providing a break location, the nonelastomeric agricultural material engagement body having a first link side between the first end and the link, the first link side proximate the link, the nonelastomeric agricultural material engagement body having a second link side between the second end and the link, the second link side proximate the link. The method includes bonding an elastomeric retention member with at least a first outrigger to the first link side and the second link side, with the at least first elastomeric outrigger arching over and away from the link. The method includes engaging an agricultural material with the unbroken nonelastomeric agricultural material engagement body. The method includes exposing the unbroken nonelastomeric agricultural material engagement body to a breaking force wherein the nonelastomeric agricultural material engagement body breaks at the link into a first broken body piece and a second broken body piece and the elastomeric retention member at least first outrigger elastomerically connects the first broken body piece to the second broken body piece.

In an embodiment the invention includes an elongated finger. The finger includes a nonelastomeric body having a first end and a distal second end, with a link between the first end and the second end, the link providing a break location. The elongated finger having a first link side between the first end and the link, the first link side proximate the link. The elongated finger having a second link side between the second end and the link, the second link side proximate the link. Te finger includes a first and a second elastomeric outrigger arching the link.

In an embodiment the invention includes a fuse. The fuse includes a nonelastomeric body having a first end and a distal second end, with a fuse link between the first end and the second end. The fuse link provides a break location. The fuse has a first fuse link side between the first end and the fuse link, the first fuse link side proximate the fuse link. The fuse has a second fuse link side between the second end and the fuse link, the second fuse link side proximate the fuse link. The fuse includes an elastomeric retention member, the elastomeric retention member bonded to the first fuse link side and the second fuse link side, the elastomeric retention member including a first elastomeric outrigger arching the fuse link.

In an embodiment the invention includes a method of retaining a broken nonelastomeric body. The method includes providing an unbroken nonelastomeric body having a first end and a distal second end, with a link between the first end and the second end, the link providing a break location. The unbroken nonelastomeric body having a first link side between the first end and the link, the first link side proximate the link. The unbroken nonelastomeric body having a second link side between the second end and the link, the second link side proximate the link. The method includes bonding an elastomeric retention member with at least a first outrigger to the first link side and the second link side, with the at least first elastomeric outrigger arching over and way from the link. The method includes exposing the unbroken nonelastomeric body to a breaking force wherein the nonelastomeric body breaks at the link into a first broken body piece and a second broken body piece and the elastomeric retention member at least first outrigger elastomerically connects the first broken body piece to the second broken body piece. Preferably the provided nonelastomeric body is a material engagement body for engaging a material, preferably agricultural crops being harvested, preferably with the nonelastomeric body moving and conveying the material it is engaging.

In an embodiment the invention includes a finger comprising a mounting end portion and an elongate free end portion opposite the mounting end portion. The finger includes a failure region at a predetermined location connecting the mounting and free end portions, the failure region being constructed so as to be weaker than at least the mounting end portion so as to break and disconnect the mounting and free end portions when the finger is subjected to a predetermined side loading condition. The finger includes a means for retaining the free end portion in connection with the mounting end portion after the failure region breaks.

In an embodiment the invention includes a method of retaining a broken nonelastomeric agricultural material engagement body. The method includes providing an unbroken nonelastomeric agricultural material engagement body having a first end and a distal second end, with a link between the first end and the second end, the link providing a break location. The unbroken nonelastomeric body having a first link side between the first end and the link, the first link side proximate the link. The unbroken nonelastomeric body having a second link side between the second end and the link, the second link side proximate the link. The method includes bonding an elastomeric retention member with at least a first outrigger to the first link side and the second link side, with the at least first elastomeric outrigger arching over and way from the link. The method includes exposing the unbroken nonelastomeric body to a breaking force wherein the nonelastomeric body breaks at the link into a first broken body piece and a second broken body piece and the elastomeric retention member at least first outrigger elastomerically connects the first broken body piece to the second broken body piece.

In an embodiment the invention includes a combine auger finger. The combine auger finger has a combine mounting end portion and an elongated free end portion opposite the combine mounting end portion. The finger includes a link at a predetermined location connecting the mounting and free end portions, the link providing a break location when the finger is subjected to a breaking force. The finger includes an elastomeric arching means for retaining the free end portion in connection with the mounting end portion upon breaking at the break location.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A-M illustrate elongated shearing pin auger material engagements fingers with a nonelastomeric elongated rigid body and an elastomeric retention member with elastomeric arched outriggers.

FIG. 2A-C illustrate the auger finger with the elastomeric retention member.

FIG. 3A-F illustrate an elongated auger material engagement finger with a nonelastomeric elongated rigid body and an elastomeric retention member with elastomeric arched outriggers.

FIG. 4A-H illustrate elongated shearing pin auger material engagements fingers engaging agricultural material in a harvesting combine with a troublesome obstruction breaking an auger finger with its elastomeric retention member retaining the broken nonelastomeric auger finger body after impact with the break force obstruction.

FIG. 5 illustrates a cross section view of an elastomeric mold for making elongated auger material engagement fingers with the elastomeric retention members with elastomeric arched outriggers bonded with the nonelastomeric elongated rigid bodies.

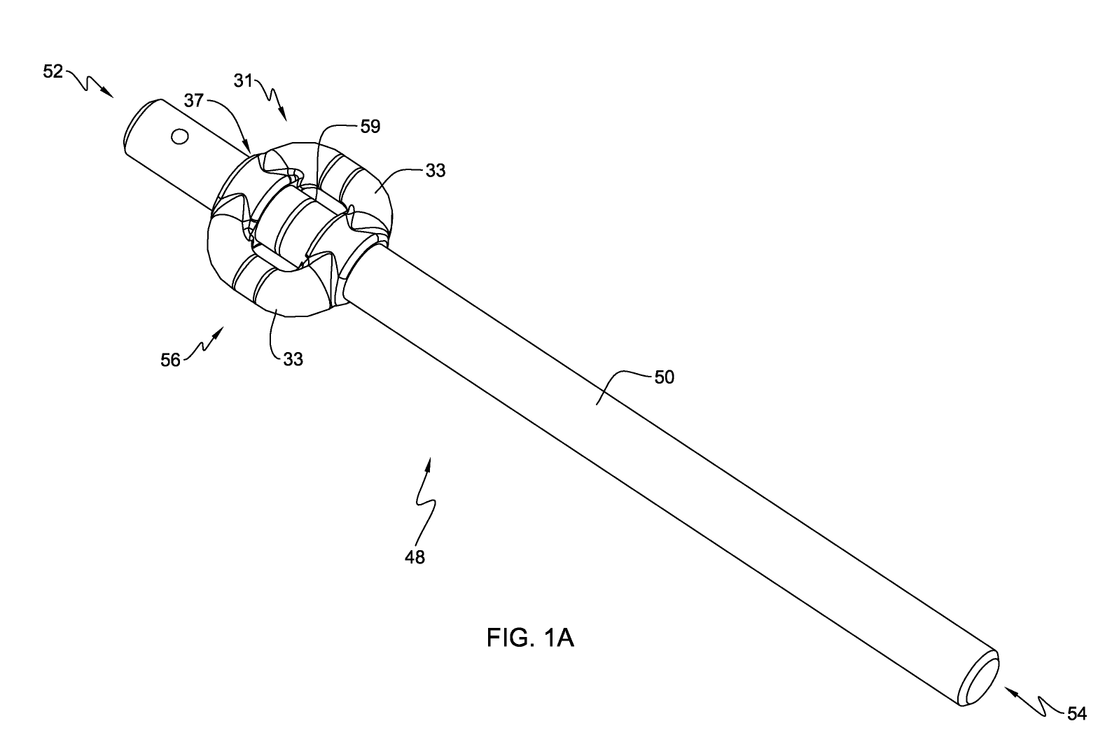

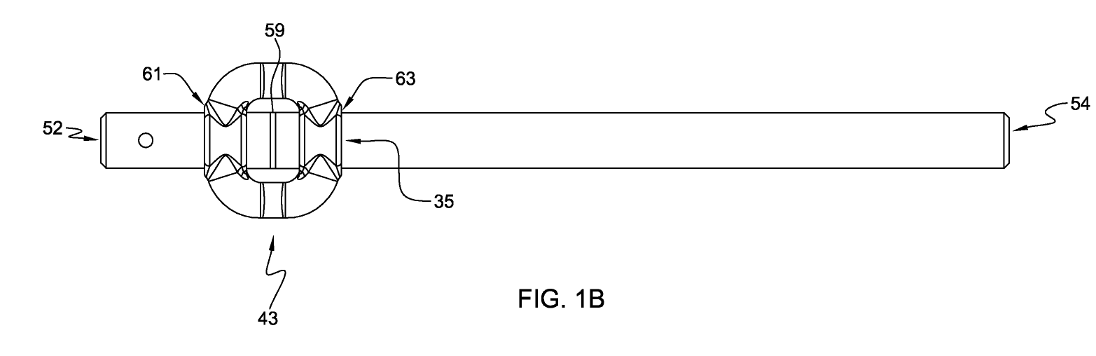

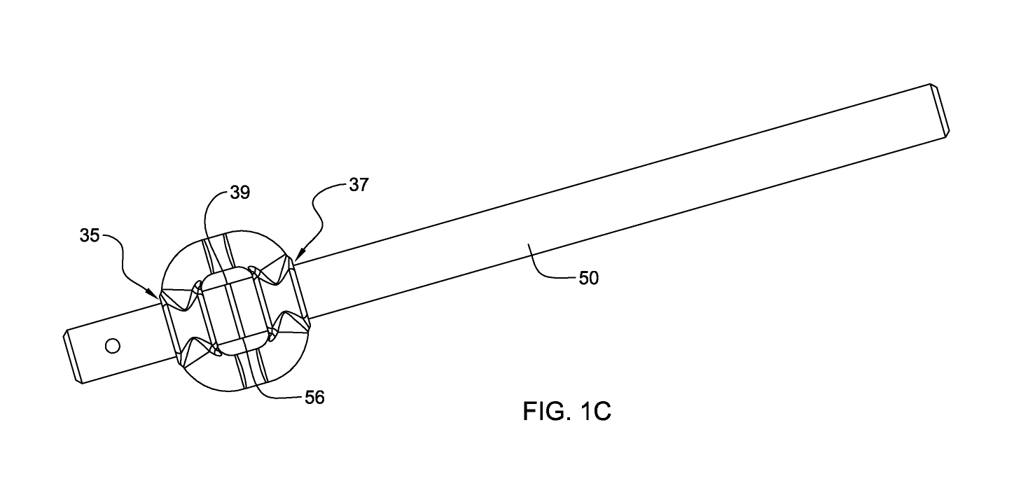

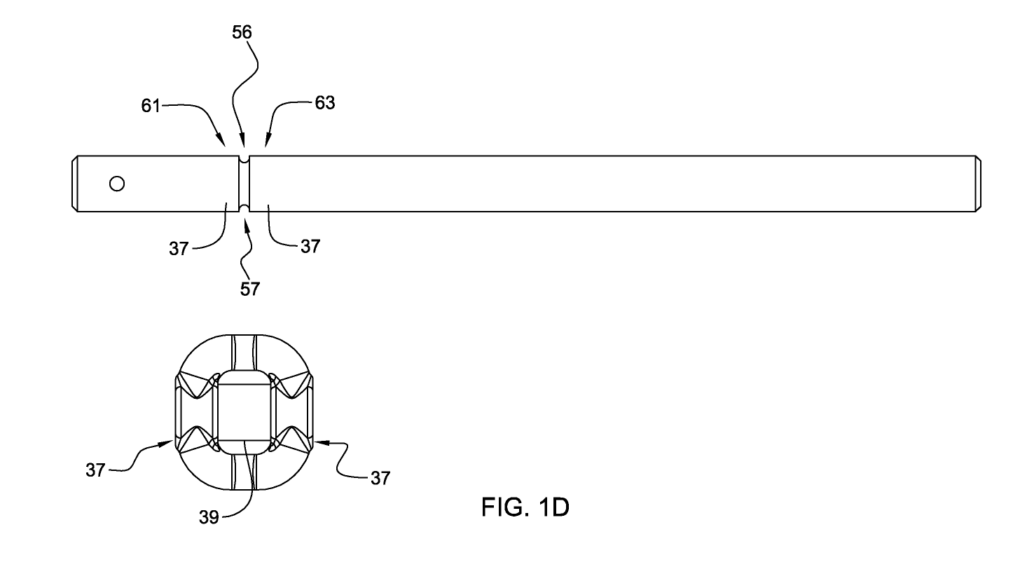

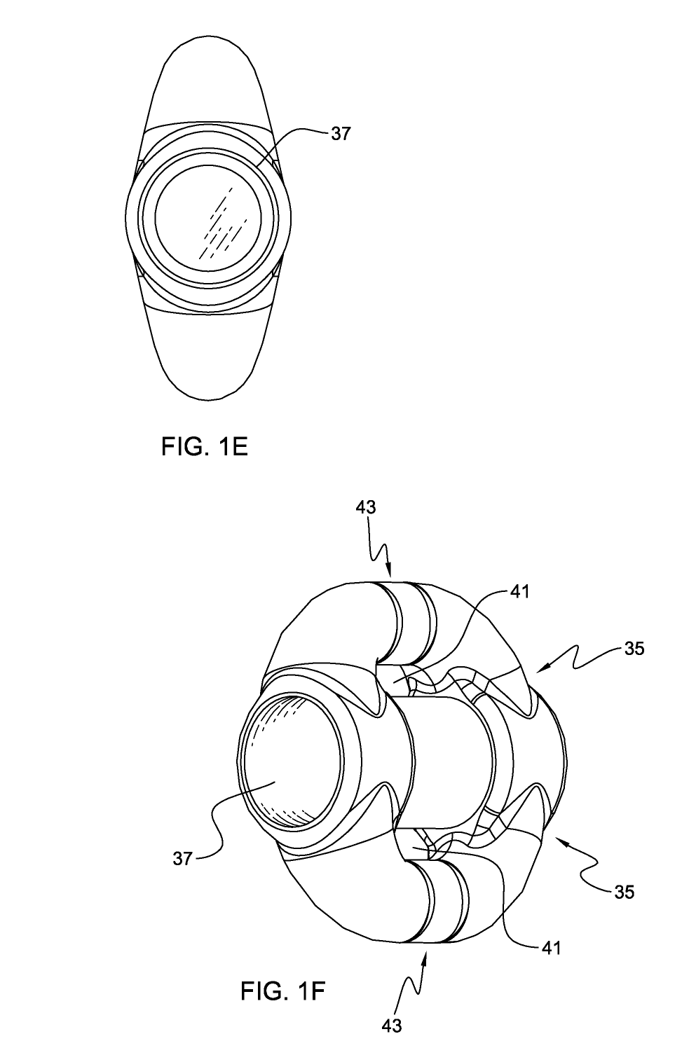

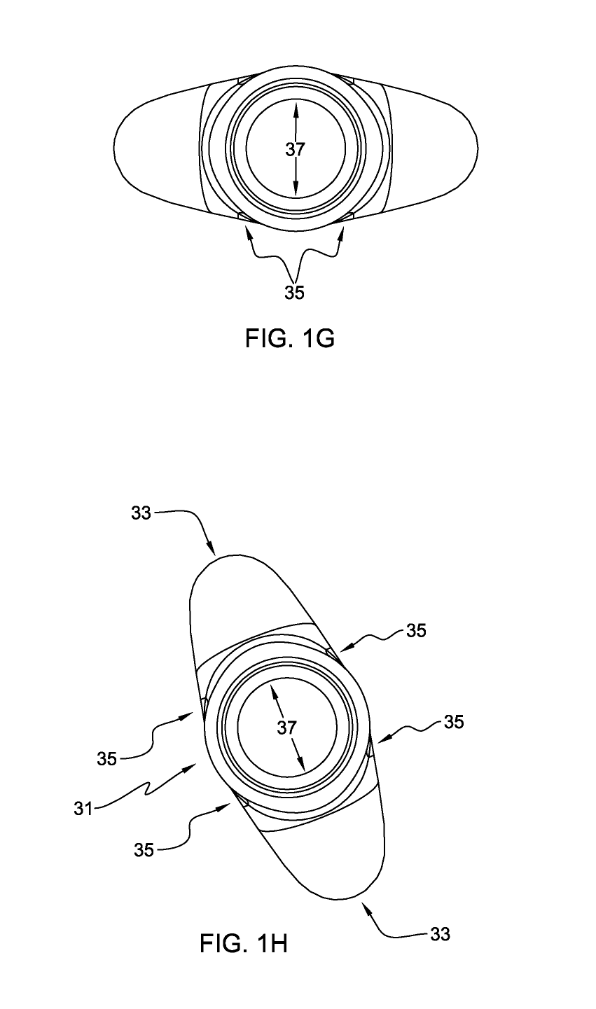

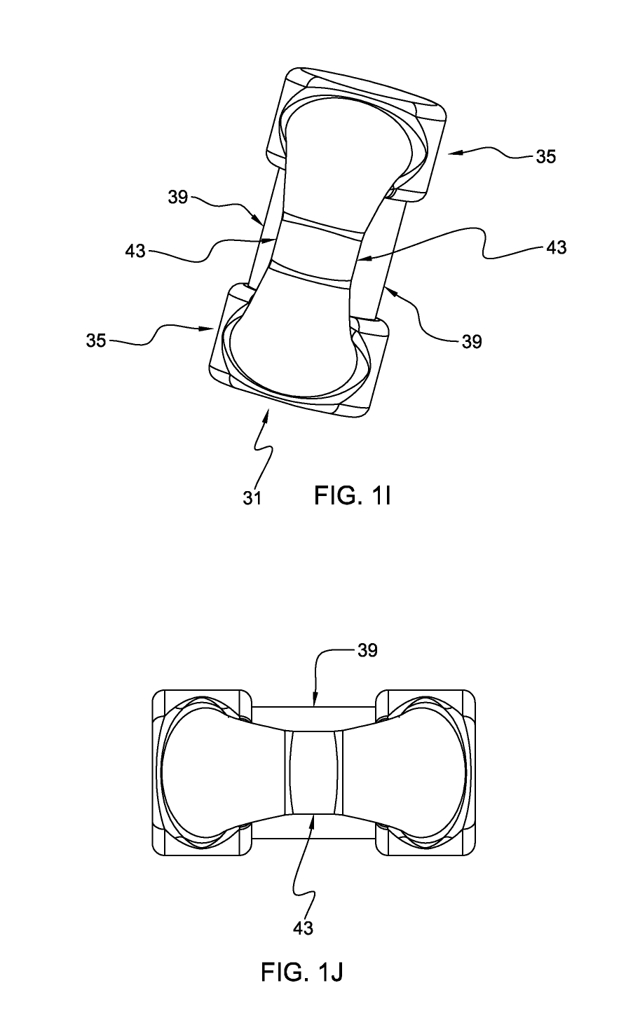

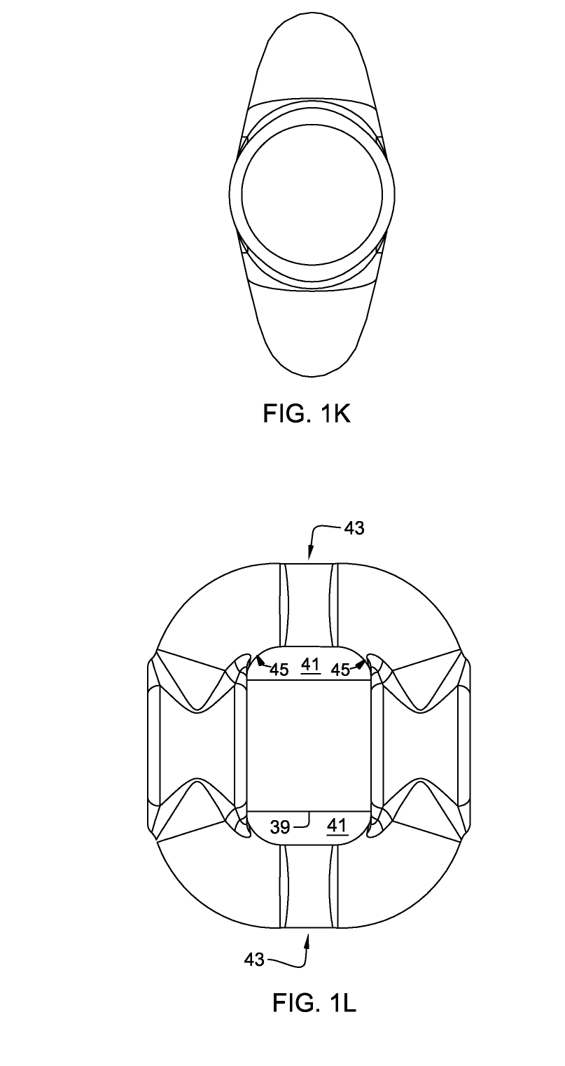

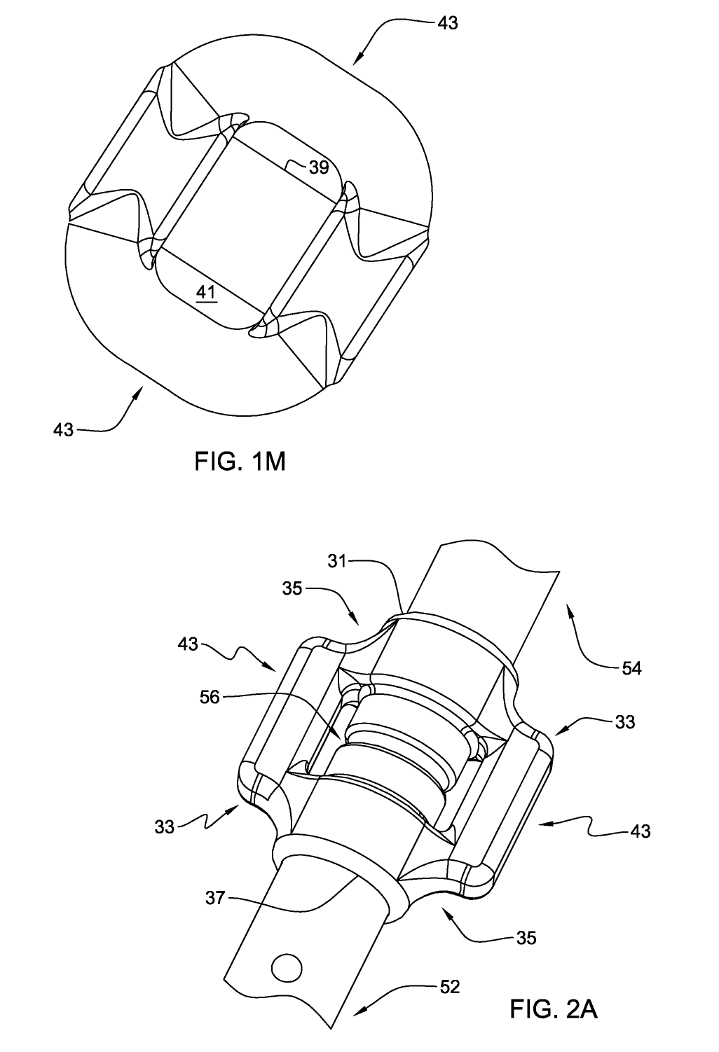

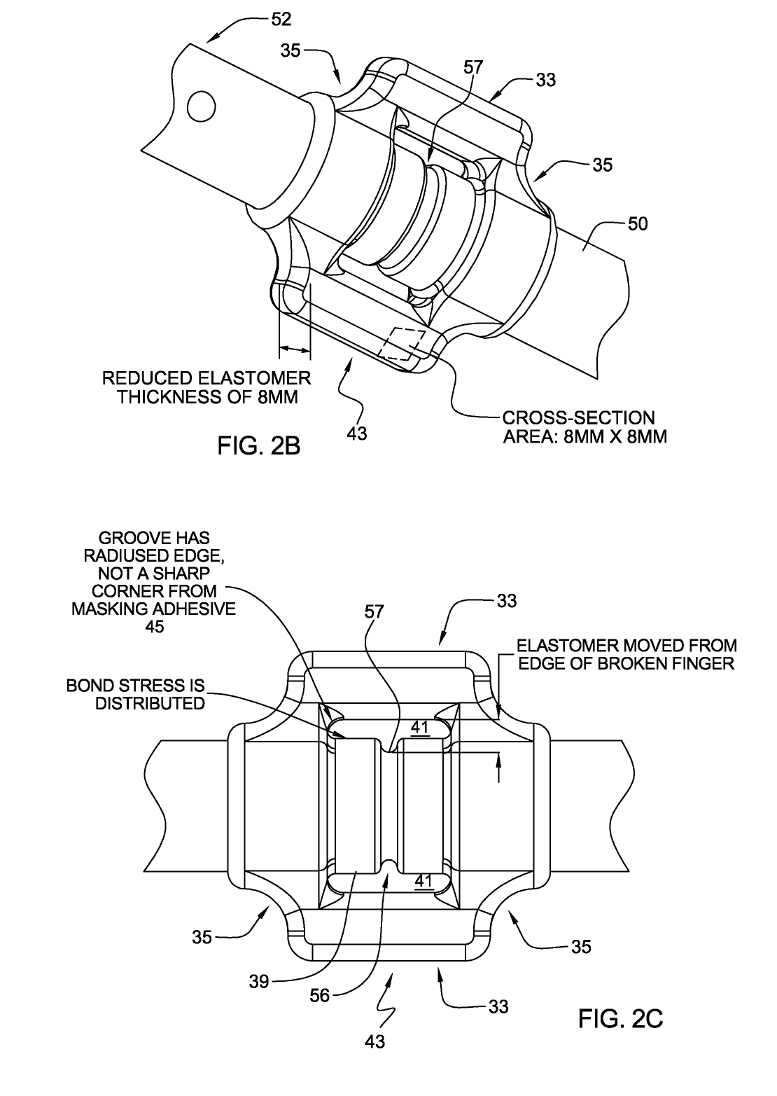

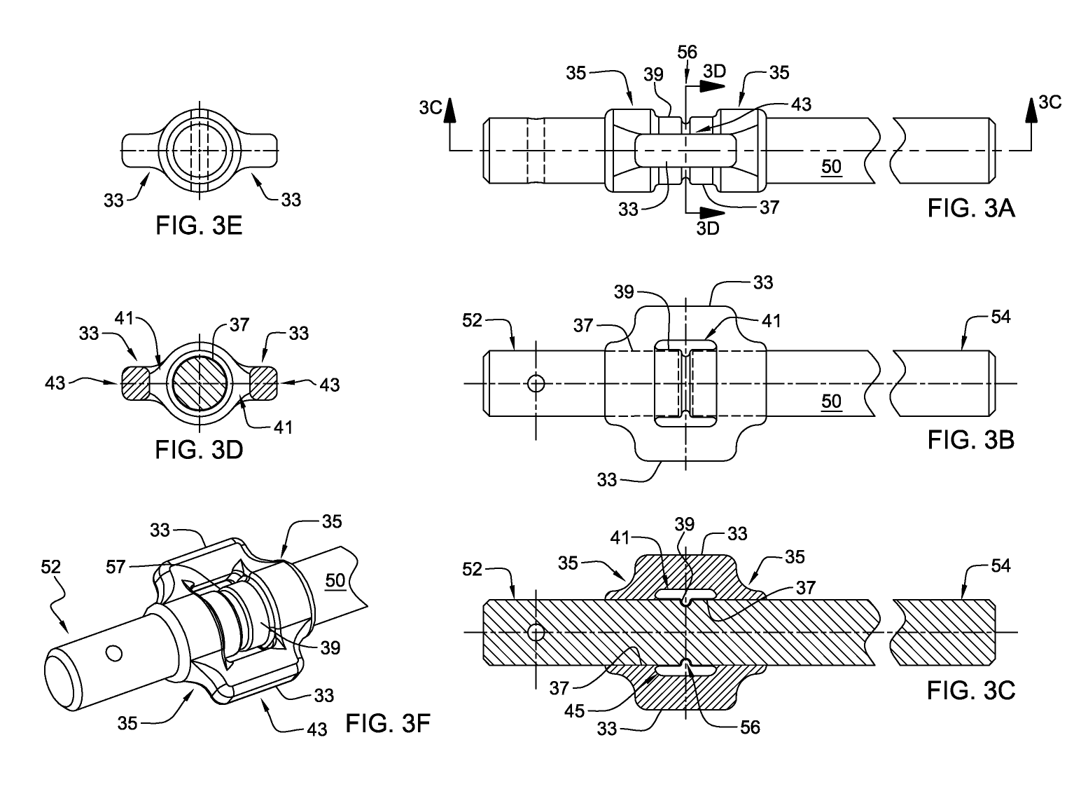

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes an agricultural material engagement auger finger. The auger finger includes a mounting end portion. The auger finger includes an elongate free end portion opposite the mounting end portion, preferably for engaging agricultural material, preferably for gathering crops being harvested. The auger finger includes a failure region at a predetermined location connecting the mounting and free end portions. The failure region is constructed to be weaker than the mounting end portion so as to break and disconnect the mounting and free end portions when the finger is subjected to a predetermined side loading condition. The auger finger includes an elastomeric tether connected between the free end portion and the mounting end portion and arching the failure region with at least a first elastomeric outrigger.

In an embodiment the invention includes an elongated agricultural material engagement finger. The finger includes a nonelastomeric body having a first end and a distal second end, with a link between the first end and the second end, the link providing a break location. The elongated finger having a first link side between the first end and the link, the first link side proximate the link. The elongated finger having a second link side between the second end and the link, the second link side proximate the link. The finger includes a first and a second elastomeric outrigger arching the link.

In an embodiment the invention includes a fuse. The fuse includes a nonelastomeric body having a first end and a distal second end, with a fuse link between the first end and the second end. The fuse link provides a break location. The fuse has a first fuse link side between the first end and the fuse link, the first fuse link side proximate the fuse link. The fuse has a second fuse link side between the second end and the fuse link, the second fuse link side proximate the fuse link. The fuse includes an elastomeric retention member, the elastomeric retention member bonded to the first fuse link side and the second fuse link side, the elastomeric retention member including a first elastomeric outrigger arching the fuse link. Preferably a load is applied to the fuse nonelastomeric body distal from the fuse link break location, preferably with the applied load applied distal and away from the the fuse link break location comprising a bending moment on the fuse nonelastomeric body finger, preferably by engaging a material with the distal second end.

In an embodiment the invention includes a method of retaining a broken nonelastomeric body. The method includes providing an unbroken nonelastomeric body having a first end and a distal second end, with a link between the first end and the second end, the link providing a break location, preferably the body is comprised of an elongated metal fuse finger. The unbroken nonelastomeric body having a first link side between the first end and the link, the first link side proximate the link. The unbroken nonelastomeric body having a second link side between the second end and the link, the second link side proximate the link. The method includes bonding an elastomeric retention member with at least a first outrigger to the first link side and the second link side, with the at least first elastomeric outrigger arching over and away from the link. The method includes exposing the unbroken nonelastomeric body to a breaking force wherein the nonelastomeric body breaks at the link into a first broken body piece and a second broken body piece and the elastomeric retention member at least first outrigger elastomerically connects the first broken body piece to the second broken body piece. Preferably the provided nonelastomeric body is a material engagement body for engaging a material, preferably agricultural crops being harvested, preferably with the nonelastomeric body moving and conveying the material it is engaging.

In an embodiment the invention includes a finger comprising a mounting end portion and an elongate free end portion opposite the mounting end portion. The finger includes a failure region at a predetermined location connecting the mounting and free end portions, the failure region being constructed so as to be weaker than at least the mounting end portion so as to break and disconnect the mounting and free end portions when the finger is subjected to a predetermined side loading condition. The finger includes a means for retaining the free end portion in connection with the mounting end portion after the failure region breaks.

In an embodiment the invention includes a method of retaining a broken nonelastomeric agricultural harvesting material engagement body. The method includes providing an unbroken nonelastomeric agricultural material engagement body having a first end and a distal second end, with a link between the first end and the second end, the link providing a break location. The unbroken nonelastomeric body having a first link side between the first end and the link, the first link side proximate the link. The unbroken nonelastomeric body having a second link side between the second end and the link, the second link side proximate the link. The method includes bonding an elastomeric retention member with at least a first outrigger to the first link side and the second link side, with the at least first elastomeric outrigger arching over and way from the link. The method includes exposing the unbroken nonelastomeric body to a breaking force wherein the nonelastomeric body breaks at the link into a first broken body piece and a second broken body piece and the elastomeric retention member at least first outrigger elastomerically connects the first broken body piece to the second broken body piece.

In an embodiment the invention includes a combine auger finger. The combine auger finger has a combine mounting end portion and an elongated free end portion opposite the combine mounting end portion. The finger includes a link at a predetermined location connecting the mounting and free end portions, the link providing a break location when the finger is subjected to a breaking force. The finger includes an elastomeric arching means for retaining the free end portion in connection with the mounting end portion upon breaking at the break location.

In an embodiment the invention includes an auger finger. The auger finger includes a mounting end portion. The auger finger includes an elongate free end portion opposite the mounting end portion. The auger finger includes a failure region at a predetermined location connecting the mounting and free end portions. The failure region is constructed to be weaker than the mounting end portion so as to break and disconnect the mounting and free end portions when the finger is subjected to a predetermined side loading condition. The auger finger includes an elastomeric tether connected between the free end portion and the mounting end portion and arching the failure region with at least a first elastomeric outrigger.

In an embodiment the auger finger 48 is comprised of an elongated rigid nonelastomeric body 50 and includes a mounting end portion 52. Preferably the elongated rigid nonelastomeric body 50 is formed from a metal. In an embodiment the body 50 is comprised of steel, preferably a steel rod. In an embodiment the body is comprised of aluminum, preferably an aluminum rod. The auger finger includes an elongate free end portion 54 opposite the mounting end portion 52. The auger finger includes a failure region 56 at a predetermined location connecting the mounting and free end portions. The failure region 56 is constructed to be weaker than the mounting end portion so as to break and disconnect the mounting and free end portions when the finger is subjected to a predetermined side loading condition. The auger finger 48 includes an elastomeric tether 31 connected between the free end portion 54 and the mounting end portion 52 and arching the failure region 56 with at least a first elastomeric outrigger 33. Preferably the elastomeric tether outrigger is capable of holding the free end portion 54 in connection with the mounting end portion 52 while allowing relative movement there between if the failure region 56 is broken. Preferably the elastomeric outrigger 33 provides movement of the free end portion relative to the mounting end portion when the failure region is broken. Preferably the at least one elastomeric outrigger 33 provides for retention and retraction of the free end portion when the failure region is broken. Preferably the failure region 56 comprises a groove 57 in the nonelastomeric finger elongated body. Preferably the mounting end 52 of the finger 48 is mounted in an internal cavity of a hollow drum of an auger rotatable in a predetermined rotational direction, such that the failure region 56 is located within the internal cavity and the free end portion 54 extends outwardly from a hole in the drum.

In an embodiment the invention includes an elongated finger. The finger includes a nonelastomeric body having a first end and a distal second end, with a link between the first end and the second end, the link providing a break location. The elongated finger having a first link side between the first end and the link, the first link side proximate the link. The elongated finger having a second link side between the second end and the link, the second link side proximate the link. The finger includes a first and a second elastomeric outrigger arching the link.

In an embodiment the elongated finger 48 includes a nonelastomeric body 50 having a first end 52 and a distal second end 54, with a link 59 between the first end and the second end, the link 59 providing a break location 56. The elongated finger has a first link side 61 between the first end 52 and the link 59, the first link side 61 proximate the link 59. The elongated finger has a second link side 63 between the second end 54 and the link 59, the second link side 63 proximate the link 59. The finger preferably includes a first and a second elastomeric outrigger 33 arching the link 59.

The first elastomeric outrigger 33 extends out from an elastomeric base 35 having an elastomeric bonding interface 37, the elastomeric bonding interface 37 extending from the first link side across the link and the second link side. Preferably the elastomeric base has an elastomer exterior surface 39 around the link, with a first elastomer void 41 between the elastomer exterior surface 39 and the first elastomeric outrigger 33 and a second elastomer void 41 between the elastomer exterior surface 39 and the second elastomeric outrigger 33. Preferably the elastomeric outriggers 33 having a narrowed cross-section area 43 proximate the link. Preferably the narrowed cross-section is taken through outrigger normal to elongated finger longitudinal axis and in alignment with fuse link break point weakened failure region circumferential groove 57. Preferably the elastomeric outrigger narrowed cross-section area 43 has a crossection length and a crossection width, with the cross-section length substantially equal to the cross-section width. In a preferred embodiment the elastomeric outrigger narrowed cross-section area 43 is substantially square. In a preferred embodiment the elastomeric outrigger narrowed cross-section area 43 is substantially circular. Preferably the outrigger cross-section area 43 is disposed substantially away from fuse link outside diameter, preferably with the outrigger cross-section area 43 distal from the fuse link outside diameter.

In an embodiment the invention includes a fuse. The fuse includes a nonelastomeric body having a first end and a distal second end, with a fuse link between the first end and the second end. The fuse link provides a break location. The fuse has a first fuse link side between the first end and the fuse link, the first fuse link side proximate the fuse link. The fuse has a second fuse link side between the second end and the fuse link, the second fuse link side proximate the fuse link. The fuse includes an elastomeric retention member, the elastomeric retention member bonded to the first fuse link side and the second fuse link side, the elastomeric retention member including a first elastomeric outrigger arching the fuse link.

In an embodiment the fuse 48 includes a nonelastomeric body 50 having a first end 52 and a distal second end 54, with a fuse link 59 between the first end and the second end. The fuse link 59 provides a break location 56. The fuse has a first fuse link side 61 between the first end and the fuse link, the first fuse link side proximate the fuse link. The fuse has a second fuse link side 63 between the second end and the fuse link, the second fuse link side proximate the fuse link. The fuse includes an elastomeric retention member 31, the elastomeric retention member bonded to the first fuse link side and the second fuse link side, the elastomeric retention member including a first elastomeric outrigger 33 arching the fuse link. Preferably the elastomeric retention member 31 includes a second opposing elastomeric outrigger 33 arching the fuse link. Preferably the elastomeric retention member has an elastomeric bonding interface 37, the elastomeric bonding interface extending from the first fuse link side across the fuse link and the second fuse link side. Preferably the elastomeric retention member has an elastomeric fuse link outside diameter 39 with an elastomer exterior surface around the fuse link 59 and the elastomeric bonding surface 37 extending across the fuse link, with an elastomer void 41 between the elastomeric fuse link outside diameter 39 and the elastomeric outrigger 33. Preferably the elastomeric outrigger 33 has a narrowed cross-section area 43 proximate the fuse link 59. Preferably the elastomeric outrigger narrowed cross-section area 43 has a crossection length and a crossection width, with the cross-section length substantially equal to the cross-section width. Preferably the elastomeric retention member has an elastomeric bonding interface, the outrigger 33 having a first elastomeric arch base 35 proximate the elastomeric bonding interface and a distal second elastomeric arch base 35 proximate the elastomeric bonding interface, wherein a breaking of the fuse link results in the first elastomeric arch base having an elastomeric bending stress and the second elastomeric arch base having an elastomeric bending stress, and the outrigger having an elastomeric bending stress with the outrigger elastomeric bending stress greater than the first elastomeric arch base elastomeric bending stress and the second elastomeric arch base elastomeric bending stress.

In an embodiment the invention includes a method of engaging an agricultural material. The method includes providing an unbroken nonelastomeric agricultural material engagement body having a first end and a distal second end, with a link between said first end and said second end, the link providing a break location, the nonelastomeric agricultural material engagement body having a first link side between the first end and the link, the first link side proximate the link, the nonelastomeric agricultural material engagement body having a second link side between the second end and the link, the second link side proximate the link. The method includes bonding an elastomeric retention member with at least a first outrigger to the first link side and the second link side, with the at least first elastomeric outrigger arching over and away from the link. The method includes engaging an agricultural material with the unbroken nonelastomeric agricultural material engagement body. The method includes exposing the unbroken nonelastomeric agricultural material engagement body to a breaking force wherein the nonelastomeric agricultural material engagement body breaks at the link into a first broken body piece and a second broken body piece and the elastomeric retention member at least first outrigger elastomerically connects the first broken body piece to the second broken body piece.

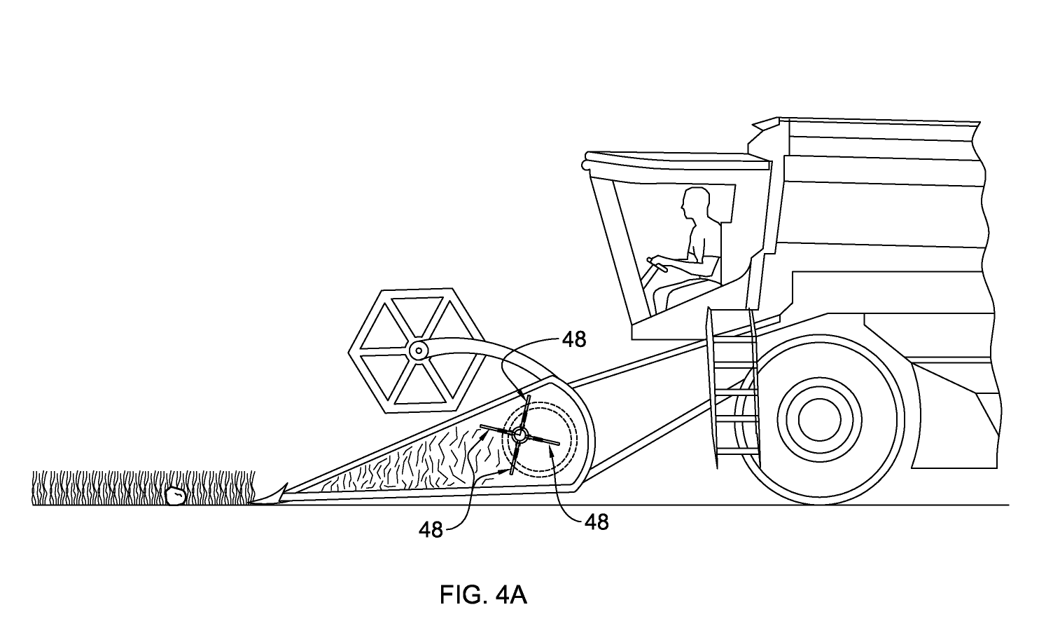

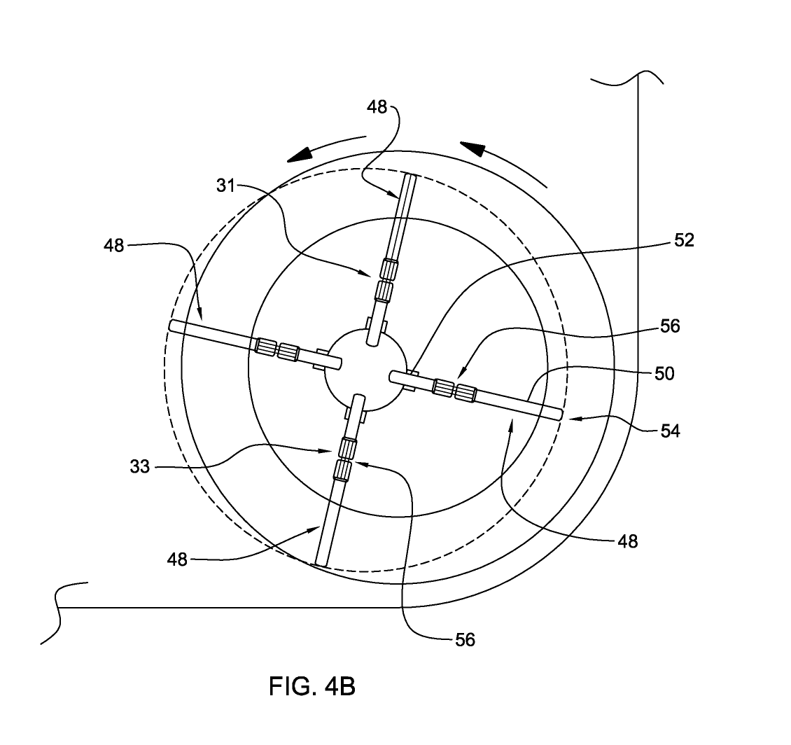

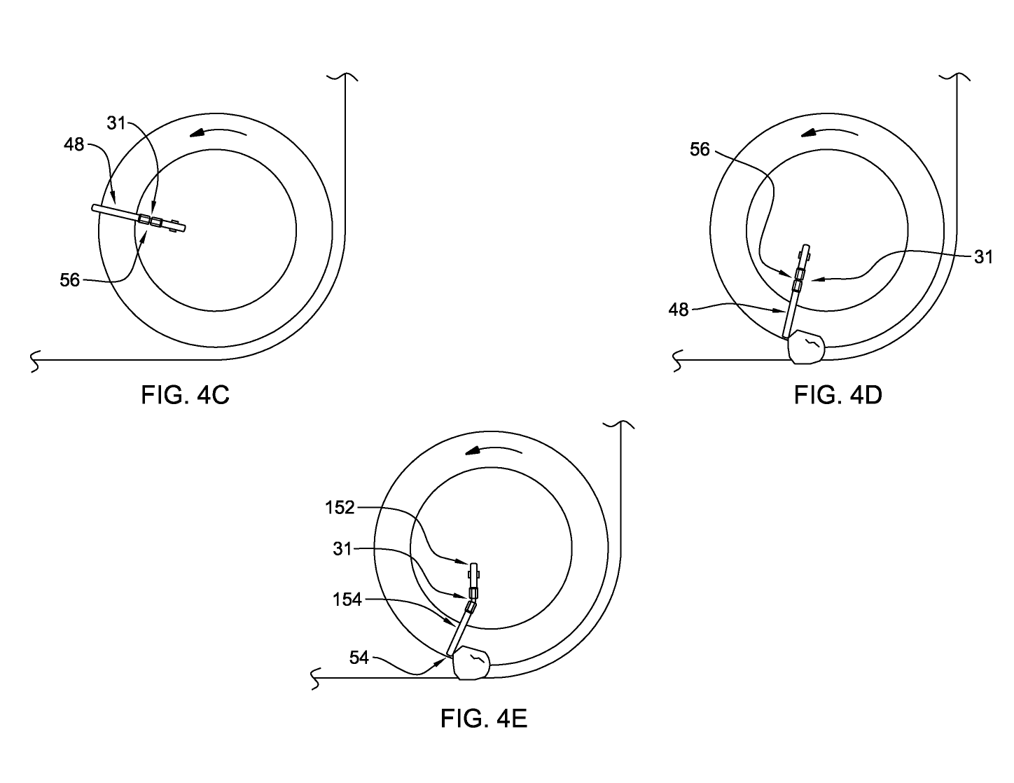

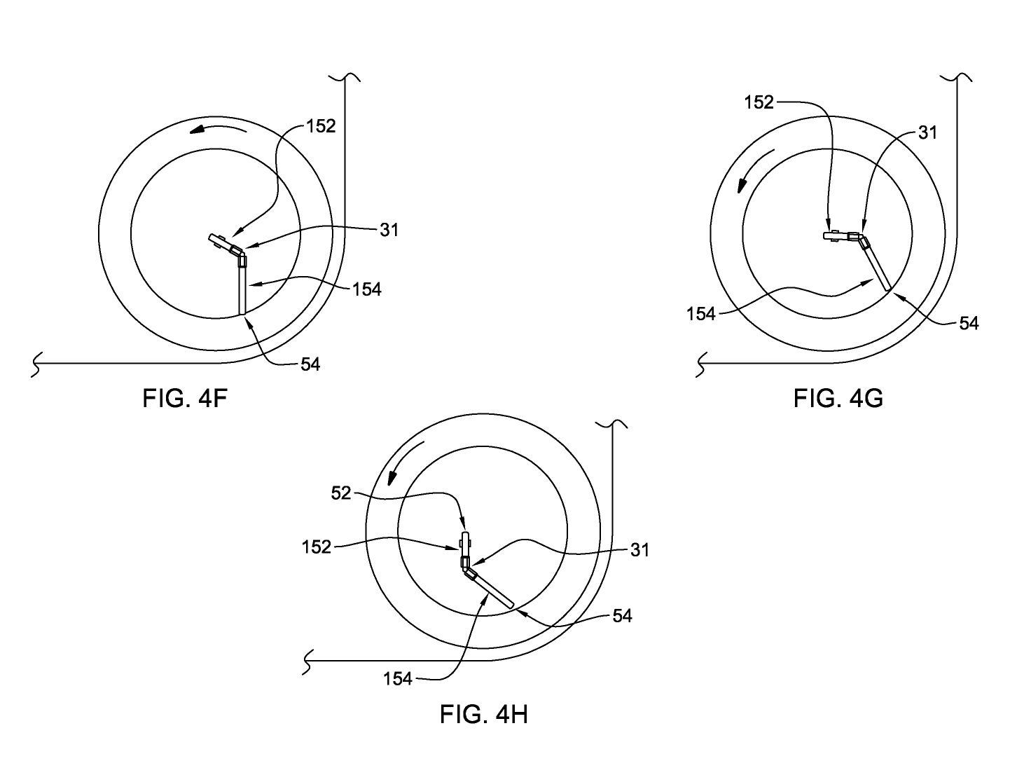

FIG. 4 illustrates an embodiment of engaging an agricultural material with unbroken nonelastomeric agricultural material engagement harvesting body elongated shearing auger fingers 48 and retaining the broken sheared nonelastomeric body agricultural material engagement harvesting auger finger 48, with the elastomeric retention member 31 retaining the free end portion 54. The elastomeric tether outrigger holds the free end portion 54 in connection with the mounting end portion 52 while allowing relative movement there between when the failure region 56 is broken, such as when the harvesting combine engages a hard noncrop object such a rock which exposes the auger finger 48 to a breaking force which breaks the link failure region 56 of the rotating combine auger finger 48. The method of engaging agricultural material and retaining a broken nonelastomeric body includes providing an unbroken nonelastomeric agricultural material engagement harvesting body 48 having a first end 52 and a distal second end 54, with a link 59 between the first end and the second end, the link providing a break location 56. The nonelastomeric agricultural material engagement body preferably has a first link side 61 between the first end and the link, the first link side proximate the link, the nonelastomeric agricultural material engagement body preferably has a second link side 63 between the second end and the link, the second link side proximate the link. The method includes bonding an elastomeric retention member 31 with at least a first outrigger 33 to the first link side 61 and the second link side 63, with the at least first elastomeric outrigger 33 arching over and away from the link 59. The method includes engaging an agricultural material with the unbroken nonelastomeric agricultural material engagement harvesting body auger fingers 48. The method includes exposing the unbroken nonelastomeric agricultural material engagement body auger finger 48 to a breaking force wherein the nonelastomeric agricultural material engagement body breaks at the link into a first broken body piece 152 and a second broken body piece 154 and the elastomeric retention member at least first outrigger elastomerically connects the first broken body piece to the second broken body piece.

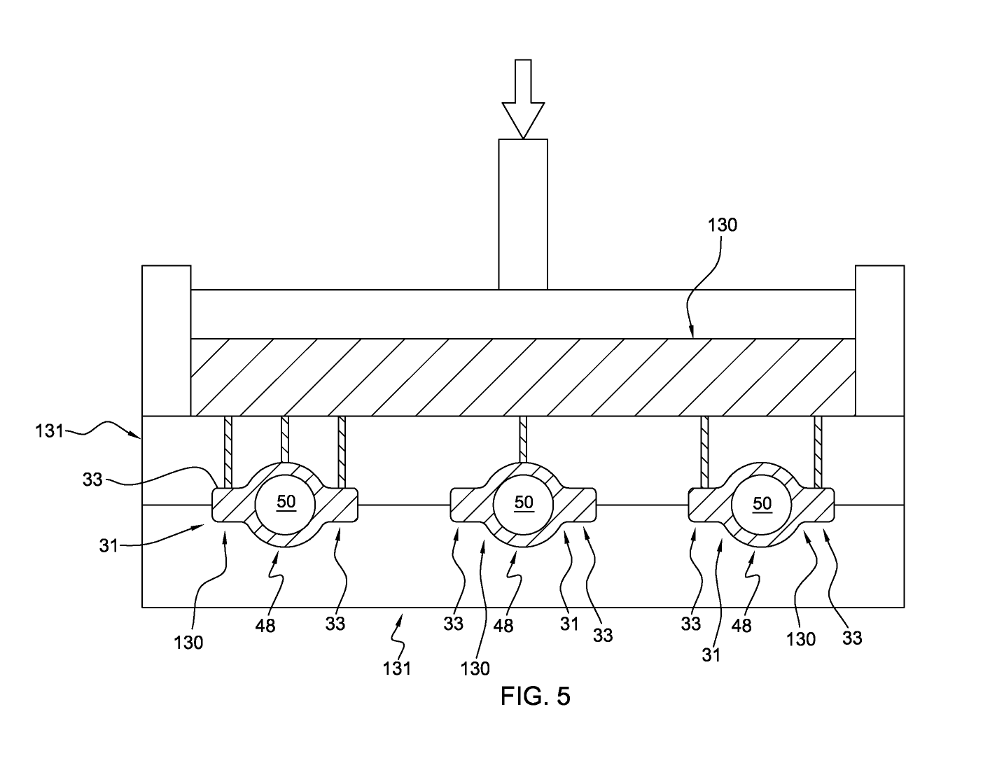

FIG. 5 illustrates a method of making the unbroken nonelastomeric agricultural material engagement harvesting body elongated shearing auger fingers 48. The unbroken nonelastomeric rigid body 50, is received in an elastomer mold 131, with elastomer 130 provided through the mold 131 to nonelastomeric rigid bodies 50 to preferably mold bond the elastomer 130 to the nonelastomeric rigid bodies, preferably with the elastomeric retention member 31 bonding to the first and second link sides, with the elastomeric outriggers 33 molded to the nonelastomeric rigid body 50 arching away from the link break location, with the outriggers comprised of molded rubber arches. Preferably the elastomer 130 is comprised of natural rubber. Preferably the mold pieces are held together and the elastomer is transferred into the mold cavities through sprue channels under an applied pressure, with the elastomer and mold temperature heated and controlled. Preferably the nonelastomeric rigid body exterior surfaces to which the elastomer is bonded are treated with an elastomer to substrate adhesive, preferably a rubber to metal adhesive, such as a Chemlok® rubber-to-metal substrate adhesive (Chemlok® rubber-to-metal substrate adhesive, LORD Corporation, 111 Lord Drive, Cary, N.C. 27511, www.lord.com) to promote bonding of the elastomer with the nonelastomeric rigid body.

In an embodiment the invention includes a method of retaining a broken nonelastomeric body 50. The method includes providing an unbroken nonelastomeric body 50 having a first end and a distal second end, with a link 59 between the first end and the second end, the link providing a failure region break location 56. The unbroken nonelastomeric body having a first link side between the first end and the link, the first link side proximate the link. The unbroken nonelastomeric body having a second link side between the second end and the link, the second link side proximate the link. The method includes bonding an elastomeric retention member 31 with at least a first outrigger 33 to the first link side and the second link side, with the at least first elastomeric outrigger 33 arching over and away from the link. The method includes exposing the unbroken nonelastomeric body to a breaking force wherein the nonelastomeric body breaks at the link 59 into a first broken body piece and a second broken body piece and the elastomeric retention member at least first outrigger 33 elastomerically connects the first broken body piece 52 to the second broken body piece 54. Preferably the invention includes providing a second outrigger 33 across the link 59, preferably on an opposite side of the link. Preferably the method includes bonding the elastomeric retention member with an elastomeric bonding interface extending from the first link side across the link and the second link side. Preferably the method includes providing the elastomeric retention member with an elastomeric link outside surface elastomer exterior proximate the link, with an elastomer void 41 between the elastomeric link outside surface and the first elastomeric outrigger. Preferably the method includes providing the elastomeric retention member outrigger 33 with a narrowed cross-section area 43 proximate the link. Preferably the method includes providing the elastomeric retention member outrigger with a narrowed cross-section area having a crossection length and a crossection width, with the cross-section length substantially equal to the cross-section width. In a preferred embodiment the narrowed crossection is substantially square. In a preferred embodiment the narrowed crossection is or substantially circular. The narrowed outrigger crossection area is disposed substantially away from fuse link OD. Preferably the method includes providing the elastomeric retention member with a first elastomeric arch base proximate the body and a second distal elastomeric arch base proximate the body, wherein after the break the first elastomeric arch base has an elastomeric bending stress and the second elastomeric arch base has an elastomeric bending stress, and the outrigger has an elastomeric bending stress with the outrigger elastomeric bending stress greater than the first elastomeric arch base elastomeric bending stress and the second elastomeric arch base elastomeric bending stress. Preferably the elastomeric retention member is provided with a first elastomeric arch base proximate the body and a second distal elastomeric arch base proximate the body, wherein the outrigger transitions from the first elastomeric arch base with a first curved edge 45 and from the second elastomeric arch base with a second curved edge 45.

In an embodiment the invention includes a material engagement finger comprising a mounting end portion and an elongate free end portion opposite the mounting end portion. The finger includes a failure region at a predetermined location connecting the mounting and free end portions, the failure region being constructed so as to be weaker than at least the mounting end portion so as to break and disconnect the mounting and free end portions when the finger is subjected to a predetermined side loading condition. The finger includes a means for retaining the free end portion in connection with the mounting end portion after the failure region breaks. Preferably the means for retaining provides for relative movement between the broken end portions and retraction of the broken off free end portion inward with the relative motion of the mounting end portion.

In an embodiment the invention includes a combine auger finger. The combine auger finger has a combine mounting end portion and an elongated free end portion opposite the combine mounting end portion. The finger includes a link at a predetermined location connecting the mounting and free end portions, the link providing a break location when the finger is subjected to a breaking force. The finger includes an elastomeric arching means for retaining the free end portion in connection with the mounting end portion upon breaking at the break location. Preferably the means for retaining provides for relative movement between the broken end portions and retraction of the broken off free end portion inward with the relative motion of the mounting end portion.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. An auger finger, comprising: a mounting end portion; an elongate free end portion opposite the mounting end portion; a failure region at a predetermined location connecting the mounting and free end portions, the failure region being constructed so as to be weaker than at least the mounting end portion so as to break and disconnect the mounting and free end portions when the finger is subjected to a predetermined side loading condition; and an elastomeric tether connected between the free end portion and the mounting end portion and arching the failure region with at least a first elastomeric outrigger so as to be capable of holding the free end portion in connection with the mounting end portion while allowing relative movement there between if the failure region is broken.

2. The auger finger of claim 1, wherein the elastomeric outrigger provides movement of the free end portion relative to the mounting end portion when the failure region is broken.

3. The auger finger of claim 1, wherein the failure region comprises a groove in the finger.

4. The auger finger of claim 1, wherein the first elastomeric outrigger is comprised of a molded rubber arch.

5. An elongated finger comprised of a nonelastomeric body having a first end and a distal second end, with a link between said first end and said second end, said link providing a break location, said elongated finger having a first link side between said first end and said link, said first link side proximate said link, said elongated finger having a second link side between said second end and said link, said second link side proximate said link, and a first and a second elastomeric outrigger arching said link.

6. An elongated finger as claimed in claim 5 wherein said first elastomeric outrigger extends out from an elastomeric base having an elastomeric bonding interface, said elastomeric bonding interface extending from said first link side across said link and said second link side.

7. An elongated finger as claimed in claim 6 wherein said elastomeric base has an elastomer exterior surface around said link, with a first elastomer void between said elastomer exterior surface and said first elastomeric outrigger and a second elastomer void between said elastomer exterior surface and said second elastomeric outrigger.

8. An elongated finger as claimed in claim 5 said elastomeric outriggers having a narrowed cross-section area proximate said link.

9. An elongated finger as claimed in claim 8 said elastomeric outrigger narrowed cross-section area having a crossection length and a crossection width, with said cross-section length substantially equal to said cross-section width.

10. A fuse comprised of a nonelastomeric body having a first end and a distal second end, with a fuse link between said first end and said second end, said fuse link providing a break location, said fuse having a first fuse link side between said first end and said fuse link, said first fuse link side proximate said fuse link, said fuse having a second fuse link side between said second end and said fuse link, said second fuse link side proximate said fuse link, an elastomeric retention member, said elastomeric retention member bonded to said first fuse link side and said second fuse link side, said elastomeric retention member including a first elastomeric outrigger arching said fuse link.

11. A fuse as claimed in claim 10 including a second opposing elastomeric outrigger arching said fuse link.

12. A fuse as claimed in claim 10 wherein said elastomeric retention member has an elastomeric bonding interface, said elastomeric bonding interface extending from said first fuse link side across said fuse link and said second fuse link side.

13. A fuse as claimed in claim 12 wherein said elastomeric retention member has an elastomeric fuse link outside diameter around said fuse link and said elastomeric bonding surface extending across said fuse link, with an elastomer void between said elastomeric fuse link outside diameter and said elastomeric outrigger.

14. A fuse as claimed in claim 10 said elastomeric outrigger having a narrowed cross-section area proximate said fuse link.

15. A fuse as claimed in claim 14 said elastomeric outrigger narrowed cross-section area having a crossection length and a crossection width, with said cross-section length substantially equal to said cross-section.

16. A fuse as claimed in claim 10 wherein said elastomeric retention member has an elastomeric bonding interface, said outrigger having a first elastomeric arch base proximate said elastomeric bonding interface and a second elastomeric arch base proximate said elastomeric bonding interface, wherein a breaking of said fuse link results in said first elastomeric arch base having an elastomeric bending stress and said second elastomeric arch base having an elastomeric bending stress, and said outrigger having an elastomeric bending stress with said outrigger elastomeric bending stress greater than said first elastomeric arch base elastomeric bending stress and said second elastomeric arch base elastomeric bending stress.

17. A method of retaining a broken nonelastomeric body, said method including providing an unbroken nonelastomeric body having a first end and a distal second end, with a link between said first end and said second end, said link providing a break location, said body having a first link side between said first end and said link, said first link side proximate said link, said body having a second link side between said second end and said link, said second link side proximate said link, bonding an elastomeric retention member with at least a first outrigger to said first link side and said second link side, with said at least first elastomeric outrigger arching over and away from said link, exposing said unbroken nonelastomeric body to a breaking force wherein said nonelastomeric body breaks at said link into a first broken body piece and a second broken body piece and said elastomeric retention member at least first outrigger elastomerically connects said first broken body piece to said second broken body piece.

18. A method as claimed in claim 17 wherein bonding said elastomeric retention member with at least a first outrigger to said first link side and said second link side, includes providing a second outrigger across said link.

19. A method as claimed in claim 17 wherein bonding said elastomeric retention member includes bonding said elastomeric retention member with an elastomeric bonding interface extending from said first link side across said link and said second link side.

20. A method as claimed in claim 17 including providing said elastomeric retention member with an elastomeric link outside surface proximate said link, with an elastomer void between said elastomeric link outside surface and said first elastomeric outrigger.

21. A method as claimed in claim 17 including providing said elastomeric retention member outrigger with a narrowed cross-section area proximate said link.

22. A method as claimed in claim 17 including providing said elastomeric retention member outrigger with a narrowed cross-section area having a crossection length and a crossection width, with said cross-section length substantially equal to said cross-section width.

23. A method as claimed in claim 17 including providing said elastomeric retention member with a first elastomeric arch base proximate said body and a second elastomeric arch base proximate said body, wherein after said break said first elastomeric arch base has an elastomeric bending stress and said second elastomeric arch base has an elastomeric bending stress, and said outrigger has an elastomeric bending stress with said outrigger elastomeric bending stress greater than said first elastomeric arch base elastomeric bending stress and said second elastomeric arch base elastomeric bending stress.

24. A method as claimed in claim 17 including providing said elastomeric retention member with a first elastomeric arch base proximate said body and a second elastomeric arch base proximate said body, wherein said outrigger transitions from said first elastomeric arch base with a first curved edge and from said second elastomeric arch base with a second curved edge.

25. A material engagement finger comprising: a mounting end portion; an elongate free end portion opposite the mounting end portion; a failure region at a predetermined location connecting the mounting and free end portions, the failure region being constructed so as to be weaker than at least the mounting end portion so as to break and disconnect the mounting and free end portions when the finger is subjected to a predetermined side loading condition; and a means for retaining said free end portion in connection with the mounting end portion after said failure region breaks.

26. A method of engaging an agricultural material, said method including providing an unbroken nonelastomeric agricultural material engagement body having a first end and a distal second end, with a link between said first end and said second end, said link providing a break location, said nonelastomeric agricultural material engagement body having a first link side between said first end and said link, said first link side proximate said link, said nonelastomeric agricultural material engagement body having a second link side between said second end and said link, said second link side proximate said link, bonding an elastomeric retention member with at least a first outrigger to said first link side and said second link side, with said at least first elastomeric outrigger arching over and away from said link, engaging an agricultural material with said unbroken nonelastomeric agricultural material engagement body, exposing said unbroken nonelastomeric agricultural material engagement body to a breaking force wherein said nonelastomeric agricultural material engagement body breaks at said link into a first broken body piece and a second broken body piece and said elastomeric retention member at least first outrigger elastomerically connects said first broken body piece to said second broken body piece.

27. A combine auger finger comprising: a combine mounting end portion; an elongated free end portion opposite the combine mounting end portion; a link at a predetermined location connecting the mounting and free end portions, said link providing a break location when the finger is subjected to a breaking force; and an elastomeric arching means for retaining said free end portion in connection with the mounting end portion upon breaking at said break location.
